(19) United States
(12) Patent Application Publication
(10) Pub. No.: US 2026/0084841 A1
(43) Pub. Date: Mar. 26, 2026

(54) GROUND WHIRL FLUTTER TEST SYSTEM AND TEST METHOD FOR ROTORCRAFT

(71) Applicant: DALIAN UNIVERSITY OF TECHNOLOGY, Dalian (CN)

(72) Inventors: Weizhe FENG, Dalian (CN); Zhiyu CHEN, Dalian (CN); Ran TAN, Dalian (CN); Jiahe ZHANG, Dalian (CN); Huijin JING, Dalian (CN); Yichen QIN, Dalian (CN); Chongxu HAN, Dalian (CN); Zhihai LIANG, Dalian (CN); Zheng CHEN, Dalian (CN); Junzhe KANG-SI, Dalian (CN); Wei QIAN, Dalian (CN)

(21) Appl. No.: 19/402,564

(22) Filed: Nov. 26, 2025

(30) Foreign Application Priority Data
Sep. 16, 2025 (CN) 202511319234.7

(51) Int. Cl. B64F 5/60; G01M 5/00

(52) U.S. Cl. CPC B64F 5/60; G01M 5/0016

(57) ABSTRACT

The present invention belongs to the technical field of flutter tests for rotorcrafts, and discloses a ground whirl flutter test system and test method for a rotorcraft. The ground whirl flutter test system for the rotorcraft comprises a hardware part and a software part. The hardware part comprises a rotor test article, a support system, force loading devices, vibration signal sensors, load cells, vibration signal acquisition cards, an industrial control computer, force signal output cards, a power amplifier and load cell signal acquisition cards. The software part of the ground whirl flutter test system for the rotorcraft comprises a rotor force and moment calculation program and a multi-input multi-output force control program running on the industrial control computer. The method can reserve all dynamic characteristics of the aircraft structure, is not restricted by the size of a wind tunnel test chamber section, does not require dynamic scaling of aircraft structures.

### TECHNICAL FIELD

The present invention belongs to the technical field of flutter tests for rotorcraft, and particularly relates to a ground whirl flutter test system and test method for a rotorcraft.

### BACKGROUND

Whirl flutter is an aeroelastic divergence phenomenon commonly encountered by aircraft such as fixed-wing propeller aircraft and tiltrotor. It displays as an aeroelastic divergence phenomenon of the pitch and yaw mode coupled precession motion of an engine nacelle, which occurs under the interaction of aerodynamics, elastic restoring force and inertia force in the flexibly installed engine nacelle and rotor system under specific rotational speed and flight speed conditions. This phenomenon may cause instability damage to the aircraft structure, which seriously threatens the flight safety. At present, it is difficult to accurately predict the phenomenon of whirl flutter through theoretical modeling and numerical simulation methods. Experiment is an important methodology for the research of whirl flutter problems. Wind tunnel tests are traditional whirl flutter test methods. However, due to the size limitations of wind tunnels, the rotorcraft cannot undergo a full-scale wind tunnel test and have to resort to dynamic scaling method. In the process of model scaling, the dynamic features and the nonlinear elements of the real aircraft are inevitably ignored, and the individual structural dynamic features of concern are only retained at last. Moreover, the results of the wind tunnel test need to be reversed to the scale of the real aircraft, therefore the flutter boundary of the real aircraft cannot be directly obtained. Moreover, the dynamic scaling law of the rotorcraft is relatively complicated, and so far, there is no complete dynamic scaling law for rotorcraft available for engineering use. In addition, the wind tunnel test consumes long cycle and high cost, and a large-scale wind tunnel test consumes huge labor cost and economic cost.

### SUMMARY

To solve the above problems, the present invention provides a ground whirl flutter test method for rotorcraft, and based on which, the whirl flutter can be conducted on a full-scale real rotorcraft under the condition of no wind tunnel. Relying on ground sensing devices, including force loading devices and industrial control devices, the rotor aerodynamics and inertia forces which act on the structure of rotorcraft can be simulated by practical loading using physical devices. And the coupling interaction between rotor aerodynamics and the rotorcraft can be achieved on the ground to reproduce the phenomenon of whirl flutter. This is a semi-physical and semi-simulation test method.

A ground whirl flutter test system of rotorcraft comprises a hardware part and a software part.

In FIG. 1, the hardware part of the ground whirl flutter test system for the rotorcraft comprises a rotor test article 1, a support system 2, force loading devices 3, vibration signal sensors 4, load cells 5, vibration signal acquisition cards 7, an industrial control computer 8, force signal output cards 10, a power amplifier 11 and load cell signal acquisition cards 14.

In FIG. 2, the rotor test article 1 comprises a wing 101, a nacelle 102, a rotor hub 103, rotor blades 104 and a power take-off shaft 105; a root of the wing 101 is fixed to the support system 2, the nacelle 102 is located at a wingtip of the wing 101, and a power system or a transmission system is installed inside the nacelle 102; the power take-off shaft 105 is fixed to the nacelle 102, and the front end of the axis of the power take-off shaft is connected with the rotor hub 103; and the rotor hub 103 is further connected with the three rotor blades 104, and is responsible for transmitting a torque from the power take-off shaft 105 to the rotor blades 104.

In FIG. 2, a local coordinate system O-X-Y-Z of the rotor test article 1 is constructed, wherein a coordinate origin O is fixed to the center of the rotor hub 103, and located at an intersection point between the axis of the power take-off shaft 105 and a rotor disc of the rotor blades 104; observation is performed from the tail of the nacelle 102 to the position of the rotor hub 103 at the head of the nacelle 102, and an X-axis is forward and coincides with the axis of the power take-off shaft 105; a Y-axis is perpendicular to the X-axis and the direction is horizontally to the right; and a Z-axis is perpendicular to an O-X-Y plane and the direction is vertically downward.

In FIG. 1, the force loading devices 3 are placed along the O-Y axis and the O-Z axis respectively, and the applied excitation forces and torques act on the point O.

The load cells 5 are located at the top ends of the force loading devices 3 and acquire force sensor signals 13, which are applied to the point O by the force loading devices 3.

The vibration signal sensors 4 are arranged along the O-Y axis and the O-Z axis and acquire vibration signals 6 at the point O along the O-Y axis and the O-Z axis.

The vibration signals 6 are acquired through the vibration signal acquisition card 7.

A force output signal 12 of each force loading device 3 is outputted through the force signal output card 10, and outputted force signals are amplificated by the power amplifier 11.

The force sensor signals 13 are acquired through the force sensor signal acquisition cards 14.

The closed-loop signal transmission process of the ground whirl flutter test system for whirl flutter of the rotorcraft is as follows: the vibration signals 6 acquired by the vibration signal acquisition cards 7 are recorded by the industrial control computer 8, and the industrial control computer 8 calculates a force that acts on the point O in the center of the rotor hub 103 according to the vibration signals 6 and a pre-programmed rotor force and moment calculation program; the industrial control computer 8 outputs a force control signals 9 to the power amplifier 11 through the force signal output card 10, the power amplifier 11 outputs the force output signal 12 after power amplification to the force loading device 3, and the force loading device 3 is driven to load the rotor test article 1; meanwhile, the force sensors 5 acquire the forces applied by the force loading devices 3 and feed back the forces to the industrial control computer 8 via the force sensor signal acquisition card 14; and the industrial control computer 8 performs closed-loop feedback control on the forces applied by the force loading devices 3 according to force signals fed back and a pre-programmed multi-input multi-output force control program, so as to achieve the accurate loading of the rotor aerodynamics and moment. Ultimately the phenomenon of whirl flutter of the rotor test article 1 can be reproduced on the ground.

The software part of the ground whirl flutter test system for the rotorcraft comprises the rotor force and moment calculation program and the multi-input multi-output force control program running on the industrial control computer 8.

The rapid rotor force and moment calculation program rapidly calculates and feeds back the forces and moments acting on the point O on the rotor hub according to the vibration signals 6 at the point O on the rotor hub. Formulas given in the literature (Rodden W, Rose T. Propeller/nacelle whirl flutter addition to MSC/Nastran. In Proceedings of the 1989 MSC World User's Conference, Anaheim, CA, USA, 26-27 Jan. 1989) are adopted for the rotor aerodynamics and gyroscopic moment, as follows:

$$\{ \begin{matrix}{F}_{z} = {q}_{∞} S [ {C}_{{z}_{6}} ( θ + \frac{\dot{z}}{V} ) + {C}_{{z}_{ψ}} ( ψ - \frac{\dot{y}}{V} ) + C \text{?} ( \dot{θ} \frac{D}{2 V} ) + C \text{?} ( \dot{ψ} \frac{D}{2 V} ) ] \\ {M}_{γ} = {q}_{∞} SD [ C \text{?} ( θ + \frac{\dot{z}}{V} ) + C \text{?} ( ψ - \frac{\dot{y}}{V} ) + \\ C \text{?} ( \dot{θ} + \frac{D}{2 V} ) + C \text{?} ( \dot{ψ} \frac{D}{2 V} ) ] \\ {F}_{y} = {q}_{∞} S [ C \text{?} ( θ + \frac{\dot{z}}{V} ) + {C}_{{y}_{ψ}} ( ψ - \frac{\dot{y}}{V} ) + C \text{?} ( \dot{θ} \frac{D}{2 V} ) + C \text{?} ( \dot{ψ} + \frac{D}{2 V} ) ] \\ {M}_{z} = {q}_{∞} SD [ {C}_{{n}_{θ}} ( θ + \frac{\dot{z}}{V} ) + {C}_{{n}_{ψ}} ( ψ - \frac{\dot{y}}{V} ) + \\ C \text{?} ( \dot{θ} + \frac{D}{2 V} ) + C \text{?} ( \dot{ψ} + \frac{D}{2 V} ) ]\end{matrix} \qquad ( 1 )$$

$${M}_{y}^{′} = - {I}_{x} Ω \dot{ψ} \qquad ( 2 )$$

$${M}_{z}^{′} = + {I}_{x} Ω \dot{θ}$$

$$\text{?} \text{indicates text missing or illegible when filed}$$

where formula (1) includes the calculation formulas for the rotor aerodynamics, where F_{z},F_{y} are the forces acting on the point O on the rotor hub by the rotor along O-Y direction and O-Z direction respectively, and M_{y}, M_{z} are the moments acting on the point O on the rotor hub around the O-Y direction and the O-Z direction. S is the area of the rotor disc of the rotor blades 104, and D is the diameter of the rotor disc of the rotor blades 104. z,y,θ,ψ are displacements at the point O along Z direction and Y direction and angular displacements around the Y-axis and the Z-axis respectively. ż,\dot{y},\dot{θ},\dot{ψ} are linear velocities at the point O along the Z direction and the Y direction, and angular velocities around the Y-axis and the Z-axis respectively; and q_{∞} is inflow dynamic pressure, and V is inflow velocity.

$$C \text{?} , C \text{?} , C \text{?} , C \text{?} , C \text{?} , C \text{?} , C \text{?} , C \text{?} , C \text{?} , C \text{?} , C \text{?} , C \text{?} , C \text{?} , C \text{?} , C \text{?} , C \text{?}$$

$$\text{?} \text{indicates text missing or illegible when filed}$$

are aerodynamic derivatives of a propeller, and calculation formulas are as follows:

$${C}_{{z}_{0}} = - ( 4 Ω {c}_{r} / V ) {I}_{1} \qquad ( 3 )$$

$${C}_{{m}_{0}} = - ( 2 Ω {c}_{r} / V ) {J}_{2}$$

$${C}_{{y}_{0}} = - ( 4 Ω {c}_{r} / V ) {J}_{1}$$

$$C \text{?} = - ( 2 Ω {c}_{r} / V ) {I}_{2}$$

$$C \text{?} = ( 4 Ω {c}_{r} / V ) {J}_{2}$$

$$C \text{?} = - ( 2 Ω {c}_{r} / V ) {I}_{3}$$

$$C \text{?} = - ( 4 Ω {c}_{r} / V ) {I}_{2}$$

$$C \text{?} = - ( 2 Ω {c}_{r} / V ) {J}_{3}$$

$$\text{?} \text{indicates text missing or illegible when filed}$$

According to symmetry,

$$C \text{?} = C \text{?} \qquad ( 4 )$$

$$C \text{?} = - C \text{?}$$

$$C \text{?} = C \text{?}$$

$$C \text{?} = C \text{?}$$

$$C \text{?} = - C \text{?}$$

$$C \text{?} = C \text{?}$$

$$C \text{?} = - C \text{?}$$

$$C \text{?} = - C \text{?}$$

$$\text{?} \text{indicates text missing or illegible when filed}$$

In formula (3), I₁,I₂,I₃,J₁,J₂,J₃, are blade integrals. For the specific form, reference is made to the literature (Rodden, W.; Rose, T. Propeller/nacelle whirl flutter addition to MSC/Nastran. In Proceedings of the 1989 MSC World User's Conference, Anaheim, CA, USA, 26-27 Jan. 1989).

Formula (2) includes the calculation formulas for the rotor gyroscopic moments.

$${M}_{y}^{′} , {M}_{z}^{′}$$

are additional moments caused by a gyroscopic effect around the O-Y and O-Z axes, where Iₓ is a moment of inertia of a rotating body composed of the rotor blades 104 and the power take-off shaft 105 along the O-X direction of a rotating shaft, and Ω is the rotational speed.

The formulas (1) and (2) are combined, and velocity terms are separated from damping terms to obtain additional stiffness and damping terms caused by the rotation of the rotor blades 104, as shown below:

$${[ K ]}_{p} = [ \begin{matrix}0 & {q}_{∞} {SC}_{{z}_{θ}} & 0 & {q}_{∞} {SC}_{{z}_{ψ}} \\ 0 & {q}_{∞} {SDC}_{{m}_{θ}} & 0 & {q}_{∞} {SDC}_{{m}_{ψ}} \\ 0 & {q}_{∞} {SC}_{{y}_{θ}} & 0 & {q}_{∞} {SC}_{{y}_{ψ}} \\ 0 & {q}_{∞} {SDC}_{{n}_{θ}} & 0 & {q}_{∞} {SDC}_{{n}_{ψ}}\end{matrix} ] \qquad ( 5 )$$

$${[ B ]}_{p} = [ \begin{matrix}{q}_{∞} & {q}_{∞} {SD}_{{z}_{θ}} & - {q}_{∞} & {q}_{∞} \\ {SC}_{{z}_{θ}} / V & D / ( 2 V ) & SC \text{?} / V & SC \text{?} D / 2 V \\ {q}_{∞} & {q}_{∞} {SDC}_{{m}_{θ}} & - {q}_{∞} & {q}_{∞} SDC \text{?} \\ {SC}_{{m}_{θ}} D / V & D / ( 2 V ) & SDC \text{?} / V & D / 2 V - I \text{?} Ω \\ {q}_{∞} & {q}_{∞} {SC}_{{y}_{θ}} & - {q}_{∞} & {q}_{∞} SC \text{?} \\ {SC}_{{y}_{θ}} / V & D / 2 V & SC \text{?} / V & D / 2 V \\ {q}_{∞} & {q}_{∞} SDC \text{?} & - {q}_{∞} & {q}_{∞} SDC \text{?} \\ {SC}_{{n}_{θ}} D / V & D / 2 V + I \text{?} Ω & SDC \text{?} / V & D / 2 V\end{matrix} ] \qquad ( 6 )$$

$$\text{?} \text{indicates text missing or illegible when filed}$$

where [K]ₚ and [B]ₚ shown in the above two formulas are additional stiffness and damping matrices caused by the rotational motion of the propeller respectively, and can be calculated under each combination of the inflow velocity V and air density ρ. A series of combinations of the inflow velocity Vᵢ,i=1,2,3 and the air density ρᵢ,i=1,2,3, . . . are generally given, and then [K]ₚ and [B]ₚ matrices under a current test state are calculated according to the mode of linear interpolation.

A feedback control program of the force loading devices 3 adopts a multi-input multi-output control method. Wherein input signals are: the displacements at the point O on the rotor hub along the O-Y direction and the O-Z direction, as well as the rotational angles around the O-Y axis and the O-Z axis.

A ground whirl flutter test method for a rotorcraft comprises the following steps:
step 1: building a hardware part of a ground whirl flutter test system for a rotorcraft;
step 2: building a software part of the ground whirl flutter test system for the rotorcraft, wherein software running on an industrial control computer 8 comprises two parts: a first part is a rotor force and moment calculation program, and a second part is a multi-input multi-output force control program;
step 2.1, the rapid rotor force and moment calculation program: inputs are vibration signals 6 on the origin O of the local coordinate system of a rotor test article 1, which are acquired and recorded by the industrial control computer 8. Outputs are equivalent forces and moments acting on the point O, which are calculated using input signals according to formulas 1-7;
step 2.2, the multi-input multi-output force control program: inputs are forces measured by load cells 5 and actually applied by force loading devices 3, and outputs are force control signals 9; first, building a controlled object dynamical model which are composed of power amplifiers 11 and force loading devices 3, and establishing the transmission relationship of the controlled object by using system identification method; and then, according to a modern control theory of multi-input multi-output, establishing control laws of links of the power amplifiers 11 and the force loading devices 3;
step 3: a ground test for whirl flutter of the rotorcraft;
step 3.1, starting the industrial control computer 8 and checking all acquisition and output channels to ensure normal operation;
step 3.2, setting rotor speed Ω, setting air density ρ, and changing inflow velocity V; applying disturbance to a rotor hub 103 and observing whether the rotor test article 1 displays persistent oscillation or divergent oscillation;
step 3.3, if the rotor test article 1 displays persistent oscillation or divergent oscillation, then the inflow velocity V at this time is a whirl flutter speed V_{EL} under the current rotor speed Ω and air density ρ; and if the vibration of the rotor test article 1 converges, then continuing to increase the inflow velocity V and repeating step 3.2 until critical speed for flutter, V_{EL} is found;
step 3.4, setting a new rotor speed Ω and air density ρ, repeating step 3.2 and finding a critical speed for whirl flutter VHI, in a next state;
step 3.5, changing structural parameters of the rotor test article 1, comprising structural support stiffness, mass distribution and moment of inertia, repeating step 3.2 and researching the influence rules of different structural parameters on the critical speed for whirl flutter V_{EL};
step 3.6, after all combined states of the rotor speed, the air density, the inflow velocity and structural parameters are completed in the test, considering that the ground test for whirl flutter of a current test model is completed, and ending the ground whirl flutter test.

The present invention has the following beneficial effects: in the present invention, the problem of conducting the test for whirl flutter on the full-size real rotorcraft is solved; ground physical sensing, loading, and measurement control devices are adopted to acquire the structural vibration signals in real time, and aerodynamic loads are generated according to the vibration signals; and the physical devices are used to load the real aircraft structure, which achieves a technical breakthrough in conducting the test for whirl flutter without relying on wind tunnels. The method can reserve all dynamic characteristics of the aircraft structure, is not restricted by the size of a wind tunnel test section, does not require dynamic scaling for the aircraft structure, has low cost and short period, and is capable of being rapidly deployed and completing the ground test.

The present invention is applicable to do ground whirl flutter tests for both tiltrotor aircraft and fixed-wing propeller aircraft.

### DESCRIPTION OF DRAWINGS

FIG. 1 is a schematic diagram of a ground whirl flutter test system for a rotorcraft;

FIG. 2 is a schematic diagram of a ground test article of a rotorcraft;

FIG. 3 is a simulation diagram of a ground whirl flutter test system for a rotorcraft;

FIG. 4 is a diagram of results of ground test simulation for whirl flutter at inflow velocity V₁=100 m/s;

FIG. 5 is a diagram of results of ground test simulation for whirl flutter at inflow velocity V₂=114.06 m/s;

FIG. 6 is a diagram of results of ground test simulation for whirl flutter at inflow velocity V₃=150 m/s;

FIG. 7 is a v-g diagram of the calculation results of frequency-domain whirl flutter;

FIG. 8 is a v-f diagram of the calculation results of frequency-domain whirl flutter;

In the figures: 1 rotor test article, 2 support system, 3 force loading device, 4 vibration sensor, 5 force sensor, 6 vibration signal, 7 vibration signal acquisition card, 8 industrial control computer, 9 force control signal, 10 force signal output card, 11 power amplifier, 12 force output signal, 13 load cell force sensor signal, 14 force sensor signal acquisition card, 101 wing, 102 nacelle, 103 rotor hub, 104 rotor blade, 105 power take-off shaft, S1 rotor test article simulation model, S2 virtual vibration signal, S3 rapid rotor force/moment solver, S4 multi-input multi-output force controller, S5 virtual force loading device, S6 virtual force signal, S7 disturbance signal, and S8 rotor hub point displacement signal.

### DETAILED DESCRIPTION

Specific embodiments of the present invention are further described below in combination with the drawings and the technical solution.

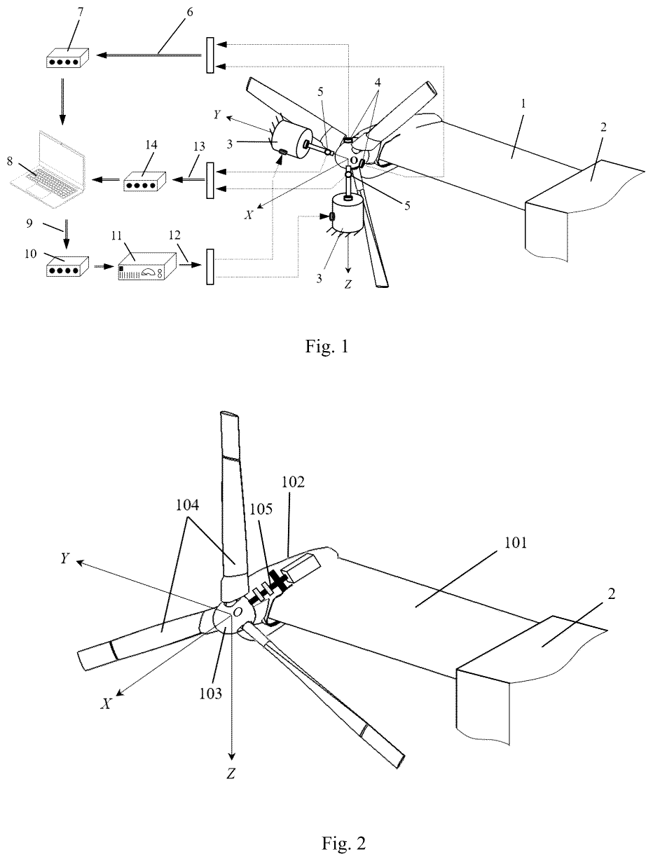

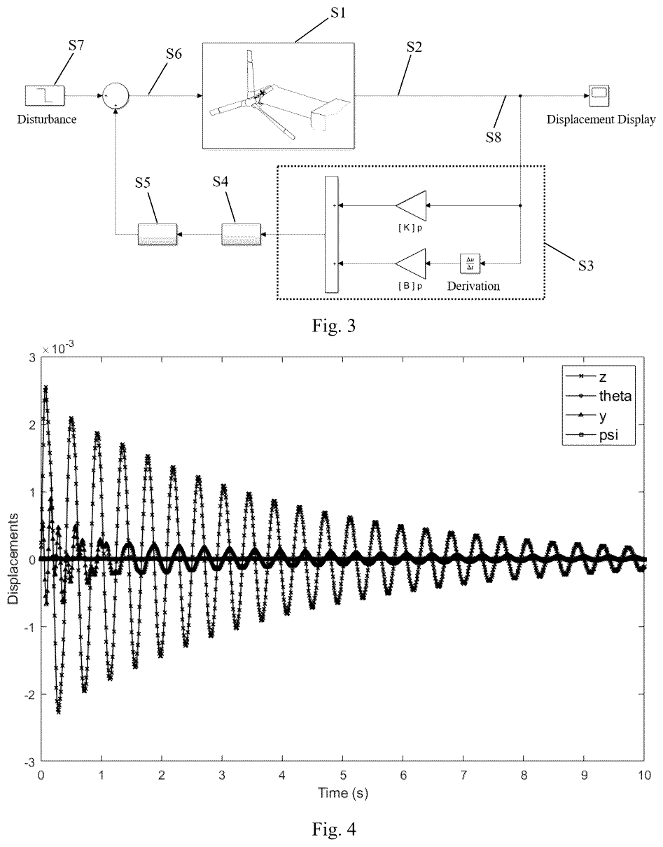

To verify the effectiveness of the invented ground test system and test method for whirl flutter of the rotorcraft, a simulation model is built for the ground whirl flutter test system for the rotorcraft shown in FIG. 1, as shown in FIG. 3, and a virtual test is conducted.

Specific steps are as follows:

Step 1: building virtual hardware of the ground whirl flutter test system for the rotorcraft.

A tested rotor test article 1 is replaced by a finite element model. The first four-order modal frequencies of the finite element model are shown in Table 1, and the mass-normalized modal displacements at the rotor hub point (point O) in the finite element model are shown in Table 2.

The first and third modes with the highest correlation to whirl flutter are selected to participate in the building of a rotor test article simulation model S1, and generalized mass, generalized stiffness and generalized damping matrices are constructed by using the mass-normalized modes, wherein the value of a structure damping ratio is 0.0. The rotor test article simulation model is built according to a structural dynamic response motion equation, as shown in FIG. 3.

Rotor structural parameters comprise: a rotor disc radius R=2889.1 mm, rotor disc area S=π·R²=26.2225 m² and the moment of inertia around the O-X axis, Iₓ=86.940 (kg·m²).

Step 2: building software of the ground whirl flutter test system for the rotorcraft. A rapid rotor force and moment calculation program running on an industrial control computer (8) comprises rotor aerodynamics calculation (formula 1) and rotor gyroscopic moment calculation (formula 2). Air density is set as ρ=1.225 kg/m³ and rotational speed is set as Ω=370 RPM. According to formula (2), the rotor gyroscopic moment can be calculated. In addition, rotor aerodynamic derivatives within the range of inflow velocity from 0 to 200 m/s are shown in Table 3. The results in Table 3 are substituted into formulas (5)-(6), and [B]ₚ and [K]ₚ matrices are calculated in the mode of linear interpolation.

In addition, a multi-input multi-output force control program also runs on the industrial control computer (8). A multi-input multi-output force controller S4 is established according to a virtual force loading device S5 of a controlled object, as shown in FIG. 3.

Step 3: conducting simulation of a ground test for whirl flutter of the rotorcraft.

As shown in FIG. 3, rotor speed is set as Ω=370 RPM, air density is set as ρ=1.225 kg/m³, and inflow velocity V is changed for simulation.

Step 3.1, setting the inflow velocity as V₁=100 m/s and conducting virtual ground test simulation. FIG. 4 is a diagram of results of the ground test simulation for whirl flutter at inflow velocity V₁=100 m/s, where z,θ,y,ψ are linear displacements and angular displacements at the point O on the rotor hub in the directions of the O-Z axis and the O-Y axis. It can be seen that the simulation result curves converge, which indicates that V₁ does not reach the critical speed for whirl flutter, V_{FL}.

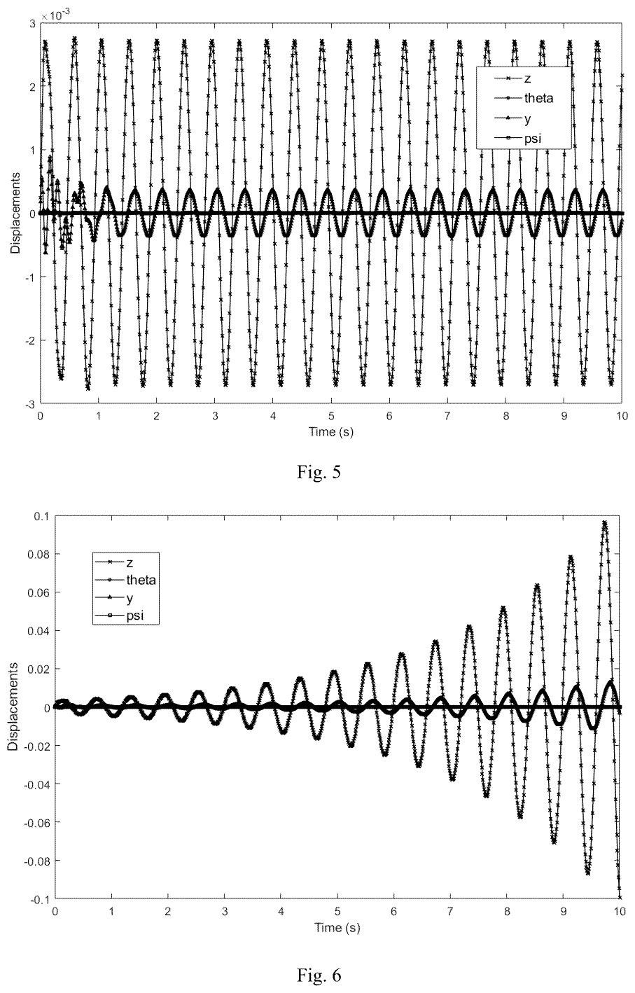

Step 3.2, setting the inflow velocity as V₂=114.06 m/s and conducting virtual ground test simulation. FIG. 5 is a diagram of results of ground test simulation for whirl flutter at inflow velocity V₂=114.06 m/s. It can be seen that the simulation result curves generate constant amplitude oscillation, which indicates that V₂ is the critical speed for whirl flutter, V_{FL}, of the system. It can be seen from FIG. 5 that the responses of the displacements z and y in the O-Z direction and the O-Y direction are relatively obvious, while the response amplitudes of the angular displacements θ,ψ are relatively small.

Step 3.3, setting the inflow velocity as V₂=150 m/s and conducting virtual ground test simulation. FIG. 6 is a diagram of results of ground test simulation for whirl flutter at inflow velocity V₃=150 m/s. It can be seen that the simulation result curves generate divergence oscillation, which indicates that V₃ exceeds the critical speed for whirl flutter, V_{FL}, and the system generates whirl flutter divergence.

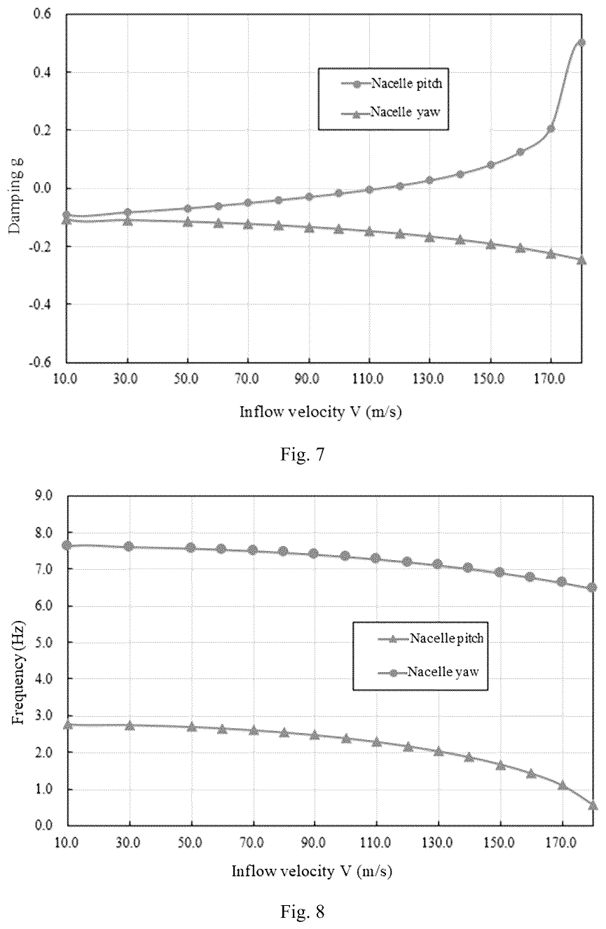

Table 4 summarizes the simulation results of the ground whirl flutter test system. To verify the correctness of the virtual simulation results of the ground whirl flutter test system, the v-g diagram and the v-f diagram of the calculation results by using frequency-domain whirl flutter method for this system are given, as shown in FIG. 7 and FIG. 8, respectively. From the frequency-domain result curves, it can be seen that the critical speed for whirl flutter is between 113 and 115 m/s for this case, and the flutter frequency is 2.2379 Hz. Compared with the results in Table 4, the errors of the flutter speed and the flutter frequency are both less than 1%, which proves the effectiveness of the system and the method.

TABLE 1
First Four-Order of Modal Frequencies

| Order | Mode | Frequency (Hz) |
|---|---|---|
| 1 | Nacelle Pitch | 2.9844 |
| 2 | Wing Bending | 4.2743 |
| 3 | Nacelle Yaw | 7.0816 |
| 4 | Wing In-Plane Bending | 12.9967 |

TABLE 2
Mass-Normalized Modal Displacements (Point O)

| | Modal Order | | | |
|---|---|---|---|---|
| Degree of Freedom | 1 | 2 | 3 | 4 |
| Ux | −3.9886E−02 | 2.5601E−02 | 6.0072E−01 | 1.2920E+00 |
| Uy | 6.9764E−02 | 5.1789E−02 | −1.8659E+00 | 7.7099E−01 |
| Uz | −2.1722E+00 | −1.9657E−01 | −9.3303E−02 | −2.0367E−02 |
| Rx | −3.5354E−04 | 6.5980E−04 | −2.2663E−06 | −7.4931E−05 |
| Ry | 1.7028E−03 | 1.6616E−03 | 1.4225E−04 | 1.0537E−05 |
| Rz | 8.0715E−05 | 6.5151E−05 | −2.8523E−03 | 2.3331E−03 |

TABLE 3
Coefficients of Rotor Aerodynamics

| Inflow Velocity (m [symbol] s) | Parameter | Data | Parameter | Data |
|---|---|---|---|---|
| 10.0 | C [symbol] | −2.678001E−02 | C [symbol] | 7.525374E−03 |
| | C [symbol] | 5.762177E−03 | C [symbol] | −4.256896E−02 |
| | C [symbol] | 0.000000E+00 | C [symbol] | −2.212036E−01 |
| | C [symbol] | −8.513792E−02 | C [symbol] | 0.000000E+00 |
| | C [symbol] | 5.762177E−03 | C [symbol] | 4.256896E−02 |
| | C [symbol] | 2.678001E−02 | C [symbol] | 7.525374E−03 |
| | C [symbol] | −8.513792E−02 | C [symbol] | 0.000000E+00 |
| | C [symbol] | 0.000000E+00 | C [symbol] | −2.212036E−01 |
| 60.0 | C [symbol] | −1.137990E−01 | C [symbol] | 4.979673E−03 |
| | C [symbol] | 1.986293E−02 | C [symbol] | −3.370123E−02 |
| | C [symbol] | 0.000000E+00 | C [symbol] | −3.090577E−02 |
| | C [symbol] | −6.740246E−02 | C [symbol] | 0.000000E+00 |
| | C [symbol] | 1.986293E−02 | C [symbol] | 3.370123E−02 |
| | C [symbol] | 1.137990E−01 | C [symbol] | 4.979673E−03 |
| | C [symbol] | −6.740246E−02 | C [symbol] | 0.000000E+00 |
| | C [symbol] | 0.000000E+00 | C [symbol] | −3.090577E−02 |
| 90.0 | C [symbol] | −1.393816E−01 | C [symbol] | 3.687685E−03 |
| | C [symbol] | 2.095558E−02 | C [symbol] | −2.858178E−02 |
| | C [symbol] | 0.000000E+00 | C [symbol] | −1.787747E−02 |
| | C [symbol] | −5.716357E−02 | C [symbol] | 0.000000E+00 |
| | C [symbol] | 2.095558E−02 | C [symbol] | 2.858178E−02 |
| | C [symbol] | 1.393816E−01 | C [symbol] | 3.687685E−03 |
| | C [symbol] | −5.716357E−02 | C [symbol] | 0.000000E+00 |
| | C [symbol] | 0.000000E+00 | C [symbol] | −1.787747E−02 |
| 120.0 | C [symbol] | −1.572341E−01 | C [symbol] | 2.806273E−03 |
| | C [symbol] | 2.063736E−02 | C [symbol] | −2.472030E−02 |
| | C [symbol] | 0.000000E+00 | C [symbol] | −1.175996E−02 |
| | C [symbol] | −4.944061E−02 | C [symbol] | 0.000000E+00 |
| | C [symbol] | 2.063736E−02 | C [symbol] | 2.472030E−02 |
| | C [symbol] | 1.572341E−01 | C [symbol] | 2.806273E−03 |
| | C [symbol] | −4.944061E−02 | C [symbol] | 0.000000E+00 |
| 120.0 | C [symbol] | −1.572341E−01 | C [symbol] | 2.806273E−03 |
| | C [symbol] | 2.063736E−02 | C [symbol] | −2.472030E−02 |
| | C [symbol] | 0.000000E+00 | C [symbol] | −1.175996E−02 |
| | C [symbol] | −4.944061E−02 | C [symbol] | 0.000000E+00 |
| | C [symbol] | 2.063736E−02 | C [symbol] | 2.472030E−02 |
| | C [symbol] | 1.572341E−01 | C [symbol] | 2.806273E−03 |
| | C [symbol] | −4.944061E−02 | C [symbol] | 0.000000E+00 |
| | C [symbol] | 0.000000E+00 | C [symbol] | −1.175996E−02 |
| 150.0 | C [symbol] | −1.722299E−01 | C [symbol] | 2.218314E−03 |
| | C [symbol] | 2.003004E−02 | C [symbol] | −2.195801E−02 |
| | C [symbol] | 0.000000E+00 | C [symbol] | −8.431272E−03 |
| | C [symbol] | −4.391602E−02 | C [symbol] | 0.000000E+00 |
| | C [symbol] | 2.003004E−02 | C [symbol] | 2.195801E−02 |
| | C [symbol] | 1.722299E−01 | C [symbol] | 2.218314E−03 |
| | C [symbol] | −4.391602E−02 | C [symbol] | 0.000000E+00 |
| | C [symbol] | 0.000000E+00 | C [symbol] | −8.431272E−03 |
| 180.0 | C [symbol] | −1.873127E−01 | C [symbol] | 1.825925E−03 |
| | C [symbol] | 1.955761E−02 | C [symbol] | −2.008407E−02 |
| | C [symbol] | 0.000000E+00 | C [symbol] | −6.466030E−03 |
| | C [symbol] | −4.016813E−02 | C [symbol] | 0.000000E+00 |
| | C [symbol] | 1.955761E−02 | C [symbol] | 2.008407E−02 |
| | C [symbol] | 1.873127E−01 | C [symbol] | 1.825925E−03 |
| | C [symbol] | −4.016813E−02 | C [symbol] | 0.000000E+00 |
| | C [symbol] | 0.000000E+00 | C [symbol] | −6.466030E−03 |
| 200.0 | C [symbol] | −1.986436E−01 | C [symbol] | 1.641442E−03 |
| | C [symbol] | 1.942297E−02 | C [symbol] | −1.926265E−02 |
| | C [symbol] | 0.000000E+00 | C [symbol] | −5.599968E−03 |
| | C [symbol] | −3.852531E−02 | C [symbol] | 0.000000E+00 |
| | C [symbol] | 1.942297E−02 | C [symbol] | 1.926265E−02 |
| | C [symbol] | 1.986436E−01 | C [symbol] | 1.641442E−03 |
| | C [symbol] | −3.852531E−02 | C [symbol] | 0.000000E+00 |
| | C [symbol] | 0.000000E+00 | C [symbol] | −5.599968E−03 |

[symbol]

indicates data missing or illegible when filed

TABLE 4
Simulation Results of Ground Whirl Flutter Test System
at Revolution Ω = 370 RPM

| Simulation Run | Simulation Results | Frequency (Hz) |
|---|---|---|
| V₁ = 100.00 m/s | Convergence | 2.2387 |
| V₂ = 114.06 m/s | Constant Amplitude | 2.239 |
| V₃ = 150.00 m/s | Divergence | 1.677 |

1. A ground whirl flutter test system for a rotorcraft, comprising a hardware part and a software part, wherein
the hardware part comprises a rotor test article—, a support system—, force loading devices, vibration signal sensors—, load cells—, vibration signal acquisition cards—, an industrial control computer—, force signal output cards—, power amplifiers—and load cell signal acquisition cards—;
the rotor test article—is fixed to the support system—;
the force loading devices—are placed along an O-Y axis and an O-Z axis respectively, and applied excitation forces and torques act on a point O;
the load cells—are located at the top ends of the force loading devices—and acquire load cell signals—, which are applied to the point O by the force loading devices—;
the vibration signal sensors—are arranged along the O-Y axis and the O-Z axis and acquire vibration signals—at the point O along the O-Y axis direction and the O-Z axis direction;
the vibration signals are acquired through the vibration signal acquisition cards—;
force output signals—of each force loading device—are outputted through the force signal output cards—, and outputted force signals are amplificated by the power amplifier—;
the load cell signals—are acquired through the load cell signal acquisition cards—;
the software part comprises a rotor force and moment calculation program and a multi—input multi-output force control program running on the industrial control computer—;
wherein the closed-loop signal transmission process of the ground whirl flutter test system for the rotorcraft is as follows: the vibration signals—acquired by the vibration signal acquisition cards—are recorded by the industrial control computer—, and the industrial control computer—calculates forces that act on the point O located in the center of a rotor hub—by using the input vibration signals—and a pre-programmed rotor force and moment calculation program; the industrial control computer outputs force control signals—to the power amplifiers—through the force signal output cards, the power amplifier outputs the force output signals—after power amplification to the force loading devices—, and the force loading devices—are driven to load the rotor test article—; meanwhile, the load cells—acquire the forces applied by the force loading devices—and feed back the forces to the industrial control computer—via the load cell signal acquisition cards—; and the industrial control computer—performs closed-loop feedback control on the forces applied by the force loading devices—according to force signals fed back and the pre-programmed multi-input multi-output force control program, so as to achieve the accurate loading of rotor aerodynamics and moment, ultimately, the phenomenon of whirl flutter of the rotor test article—is reproduced on the ground.

2. The ground whirl flutter test system for the rotorcraft according to claim 1, wherein the rotor test article—comprises a wing—, a nacelle—, the rotor hub—, rotor blades and a power take—off shaft—; a root of the wing—is fixed to the support system—, the nacelle—is located at a wingtip of the wing—, and a power system or a transmission system are installed inside the nacelle—; the power take-off shaft—is fixed to the nacelle—, and the front end of the axis of the power take-off shaft is connected with the rotor hub—; and the rotor hub—is further connected with the three rotor blades—, and is responsible for transmitting a torque from the power take-off shaft—to the rotor blades—.

3. The ground whirl flutter test system for the rotorcraft according to claim 2, wherein a local coordinate system O-X-Y-Z of the rotor test article—is constructed, wherein a coordinate origin O is fixed to the center of the rotor hub—, and located at an intersection point between the axis of the power take-off shaft—and a rotor disc of the rotor blades—; observation is performed from the tail of the nacelle—to the position of the rotor hub—at the head of the nacelle—, and an X-axis is forward and coincides with the axis of the power take—off shaft—; a Y-axis is perpendicular to the X-axis and the direction is horizontally to the right; and a Z-axis is perpendicular to an O-X-Y plane and the direction is vertically downward.

4. The ground whirl flutter test system for the rotorcraft according to claim 3, wherein the rotor force and moment calculation program calculates and feeds back the rotor aerodynamics and rotor gyroscopic moment acting on the coordinate origin O on the rotor hub—according to the vibration signals at the coordinate origin O on the rotor hub—.

5. The ground whirl flutter test system for the rotorcraft according to claim 4, wherein a feedback control program of the force loading devices—adopts a multi-input multi-output control method; and input signals are: displacements at the coordinate origin O on the rotor hub-along an O-Y direction and an O-Z direction, as well as rotational angles around the O-Y axis and the O-Z axis.

6. A ground whirl flutter test method for a rotorcraft using the ground whirl flutter test system for the rotorcraft according to claim 1, comprising the following steps:
step 1: building a hardware part of the ground whirl flutter test system for the rotorcraft;
step 2: building a software part of the ground whirl flutter test system for the rotorcraft, wherein software running on an industrial control computer comprises two parts: a first part is a rotor force and moment calculation program, and a second part is a multi-input multi-output force control program;
step 2.1, the rapid rotor force and moment calculation program: inputs are vibration signals—on an origin O of a local coordinate system of a rotor test article—which are acquired and recorded by the industrial control computer—, outputs are equivalent forces and moments acting on the point O, which are calculated using input signals according to formulas (1)-(7);
step 2.2, the multi-input multi-output force control program: inputs are forces measured by load cells—and actually applied by force loading devices, and outputs are force control signals—; first, building a controlled object dynamical model which is composed of power amplifiers—and force loading devices—, and establishing a transmission relationship of a controlled object by using system identification method; and then, according to a modern control theory of multi-input multi-output, establish the control rule of links of the power amplifier—and the force loading devices—;
step 3: a ground whirl flutter test for the rotorcraft;
step 3.1, starting the industrial control computer—and checking all acquisition and output channels to ensure normal operation;
step 3.2, setting rotor speed Ω, setting air density ρ, and changing inflow velocity V;
applying disturbance to a rotor hub—and observing whether the rotor test article—displays persistent oscillation or divergent oscillation;
step 3.3, if the rotor test article—displays the persistent oscillation or critical divergent oscillation, then the inflow velocity V at this time is a whirl flutter speed V_{FL} under the current rotor speed Ω and air density ρ; and if the vibration of the rotor test article—converges, then continuing to increase the inflow velocity V and repeating step 3.2 until critical speed for flutter, V_{FL} is found;
step 3.4, setting a new rotor speed Ω and air density ρ, repeating step 3.2 and finding a critical speed for whirl flutter, V_{FL} in a next state;
step 3.5, changing other structural parameters of the rotor test article—, comprising structural support stiffness, mass distribution and moment of inertia, repeating step 3.2 and studying the influence rules of different structural parameters on the critical speed for whirl flutter, V_{FL};
step 3.6, after all combined states of the rotor speed, the air density, the inflow velocity and structural parameters are completed in the test, considering that the ground whirl flutter test of a current test model is completed, and ending the ground whirl flutter test.
